(19) United States
(12) Patent Application Publication
(10) Pub. No.: US 2007/0098247 A1
(43) Pub. Date: May 3, 2007

(54) Method for checking the pattern density of a semiconductor chip design with variable checking box size and variable stepping distance

(76) Inventors: David I. Sanderson, Walden, NY (US); Christopher M. Schnabel, Poughkeepsie, NY (US)

Correspondence Address: H. Daniel Schnurmann;Intellectual Property Law, IBM Corporation, Dept. 18G, Building 300-482, 2070 Route 52, Hopewell Junction, NY, 12533, US

(21) Appl. No.: 11/260,007

(22) Filed: Oct. 27, 2005

(51) Int. Cl. G06K 9/00

(52) U.S. Cl. 382/145

(57) ABSTRACT

A method for checking the pattern density of a chip layout is described. Initially, the design area is subdivided into a plurality of large checking boxes. Large portions of the chip are discarded from further checking if they are found to fall within acceptable limits at the more stringent and scaled box size. The box size is successively reduced using an appropriate density for each box size until key problem areas are identified on the chip. After the check of a non-failing area, the reduction in checking box size is determined by the detected pattern density. Once the checking box size approximates that of the checking box size as dictated by the groundrule, the checking box size is fixed to that of the groundrule. Rather than using steps that are of the order of the width of the checking box, the box is stepped in an adaptive manner where the distance stepped is relative to the measured pattern density to guarantee that all the errors are captured and reported, regardless of their location from the origin.

### BACKGROUND OF THE INVENTION

This invention relates to the design and manufacture of semiconductor wafers and more particularly to a method for checking the pattern density of a chip design layout.

As the CMOS technology evolves and moves towards the 90 nm generation and beyond, fabrication costs associated thereof play an ever increasing role. In order to maximize the yield, process engineers must achieve a consistent predictability and uniformity of the manufactured devices, contact shapes, channel lengths, interlayer dielectrics, and the like.

In the aforementioned sub-micron technologies, larger process windows and uniform manufacturing is becoming increasingly more difficult and constraining, particularly, on the physical layouts and their ensuing verification requirements.

The problem is particularly acute when attempts are made to control manufacturing variations related to Chemical Mechanical Polish (CMP) which requires evenly distributed patterns on layers that make up the fabricated semiconductor wafer. If the local density on key layers is too high or too low, CMP can dish away parts of the wafer stack, removing regions of active semiconductor, metal, or important dielectrics. The current method for checking the local pattern density in the design data is to step a checking box across the design and report back the ratio of the area of the layer of interest to the area of the checking box. (Note: Pattern density is the ratio of the total area of design shapes within a checking box to the area of the same checking box). The step size is typically either 50% or 100% of the checking box width to avoid long checking times, but it still ensures that the entire design is checked.

One problem with this approach is that large areas where no patterns exist are checked with the same, small-sized checking box. Much of the checking time used for large designs is spent checking and reporting regions with no density error. A compromise is made for the box and stepping size to optimize the pattern density check times. The area of the box and step size must be sufficiently large to make the checking of large designs possible, and yet sufficiently small to prevent local areas on the wafer from being too dense or too sparse on a particular layer. However, a mid-sized checking box and step size creates a two-dimensional sampling problem which makes the results of the check dependent on the relative location of shapes and patterns in the design. When a boundary between successive checking boxes divides a failing pattern, the fail may not be reported by the check if the area of the pattern is distributed between two or more checking boxes and does not exceed the density threshold. As a result, errors that exist at one level of hierarchy may not be reported until the origin of the design shifts at a higher level of the hierarchical layout, thereby shifting the edges of the checking boxes. A more critical case is that high density areas may not be reported at all. A pattern density checking algorithm is required that does not sacrifice accuracy for a reduced checking time.

The present state of the art may be illustrated in a publication by A. B. Kahng, et al, “Filling Algorithms and Analyses for Layout Density Control,” published in the IEEE Transactions on Computer-Aided Design of Integrated Circuits and Systems, vol. 18, April 1999, pp. 445-462, which describes a method for discarding large areas that cannot fail pattern density. Although this technique is advantageous in its use of different checking box sizing and its ability of providing efficient positioning algorithms to perform density checks, it is hampered by its limitation of consistently dividing the checking box side by 2, and is further stymied by its inability to skip forward when the density is very high.

As a result, there is a distinct need in industry for a hierarchical local pattern density checker that not only uses checking boxes of variable size but which is directed toward checking to a more stringent density that is directly correlated to the groundrule density and to the size of the box being checked.

### OBJECTS AND SUMMARY OF THE INVENTION

Accordingly, it is an object of the invention to detect patterns that exceed the threshold (or groundrule) pattern density regardless of where it stands in the design data relative to the origin of the design.

It is another object to provide a method for hierarchically reducing the checking box size, discarding areas that are guarantied to pass, and then fracturing questionable areas into smaller checking areas.

It is still another object to check pattern densities by way of variable steps in either one dimension or two-dimensions.

It is a further object to account for minivariations which occur in layout post-processing for CMP uniformity.

These and other objects are achieved by initially breaking the design area into a handful of large checking boxes. Large portions of the chip are then discarded from further checking if they are found to fall within acceptable limits at the more stringent and scaled box size. The box size is successively reduced using an appropriate density for each box size until key problem areas are identified on the chip. After the check of a non-failing area, the reduction in checking box size is determined by the detected pattern density. Once the checking box size is close to that of the checking box size as dictated by the groundrule, the checking box size is set to that of the groundrule. Rather than using steps that are on the order of the width of the checking box, the box is stepped in an adaptive manner where the distance stepped is relative to the measured pattern density to guarantee that all the errors are captured and reported, regardless of their location from the origin.

The invention provides a method for checking the density of a chip layout that includes the steps of:
a) setting dimensions of an area to be checked, determining the area of the pattern contained therein, and determining its associated pattern density;
b) determining whether the associated pattern density guarantees a pass or fail when compared to a groundrule checking box size and its corresponding pattern density;
c) subdividing the checked area based on: 1) the associated pattern density; 2) the size of the area to be checked; and 3) the groundrule checking box size and pattern density thereof; and
d) iteratively repeating steps a) through c) for each subdivided area.

The invention further provides a method for checking the density of a chip layout that includes the steps of:
a) superimposing a fixed size checking box over an area to be checked;
b) determining the area of the pattern contained within the checking box, and its associated pattern density;
c) determining whether the associated pattern density constitutes a pass or fail when compared to a groundrule pattern density;
d) moving the fixed size checking box a distance based on 1) the associated pattern density; 2) the area of the fixed size checking box; and 3) the groundrule pattern density; and
e) iteratively repeating steps a) through d).

### BRIEF DESCRIPTION OF DRAWINGS

These and other objects, aspects and advantages of the invention will be better understood from the detailed preferred embodiment of the invention when taken in conjunction with the accompanying drawings.

FIG. 1 is a diagram illustrating the reduced density required for a pattern density checking box that is larger than the groundrule pattern density checking box.

FIG. 2 is a diagram illustrating different pattern density scenarios when a layout area is subdivided.

FIG. 3 is a flow chart detailing each step in the algorithm for hierarchical pattern density checking with variable zoom and quick discard.

FIG. 4 is a flow chart detailing each step in the pattern density checking algorithm with a variable checking box step.

FIG. 5 is a diagram illustrating the method for determining the maximum possible step of the checking box in the one dimensional variable stepping algorithm.

FIG. 6 is a diagram illustrating the method for determining the maximum possible movement of the checking box in the two dimensional variable stepping algorithm.

### DETAILED DESCRIPTION OF THE INVENTION

For the purposes of the present description, there will be a focus on a groundrule mandated local pattern density maximum. The same concepts may also be applied to a pattern density minimum by one skilled in the art.

Local pattern density is defined as the amount of pattern within a checking box of a size specified by the same groundrule. For example, a groundrule may specify that the maximum pattern density in a chip is 50% within a checking box of 20 μm per edge. In this example, a design in which a 20 μm×20 μm box can be placed and contain more than 200 μm² of pattern is considered to fail because the density of pattern is greater than 50%.

The inventive method requires that the area of the pattern density of the entire chip must be found. Based on the pattern density one can pass the entire chip, fail the entire chip, or decide that it must be analyzed in smaller areas. This will become more understandable when looking at extreme cases. If the entire design contains no pattern (i.e., the pattern density is zero), regardless of the size of the checking box, then it is known that there is insufficient area in the design to fail, and the entire design may be passed. Conversely, a design having ‘100% pattern’ is guaranteed to have a failing area within a checking box overlaid on the design. In such an instance the design may be failed. A design that falls between the thresholds (which can be calculated) must be further subdivided and inspected.

The invention provides a method wherein the number of subdivisions is chosen based on the detected pattern and its associated pattern density. The intent is to select a factor by which to subdivide the design such that the probability of finding a fail quickly is maximized. Such an optimization is dependent upon a plurality of factors, which includes knowledge of the design itself. The homogeneity of the design will affect the optimal method of choosing the factor for subdivision. Again considering the extreme cases, if there is a design with relatively high pattern density, it is likely that a fail will be rapidly detected. Therefore, it is advantageous to subdivide using a large factor. In areas with relatively low pattern density, it is more advantageous to use a small factor such that the area of the subdivision is larger, which increases the likelihood of passing a single large area without requiring further subdivisions. An allowable range is chosen for the factor where the smallest allowable factor is 2, resulting in a binary subdivision, and the largest factor results in a subdivision equal to the checking box size. Each subdivided area is then processed in the same manner as the total design was processed. Based on the detected pattern and its associated density, the subdivided area passes, fails, or requires further subdivision. This hierarchical iteration continues until the subdivided area is close to that of the checking box.

To better understand the method of the present invention and to quantify the thresholds, it is required that a comparison be made of the pattern detected, the size of the area to be checked, and the groundrule itself.

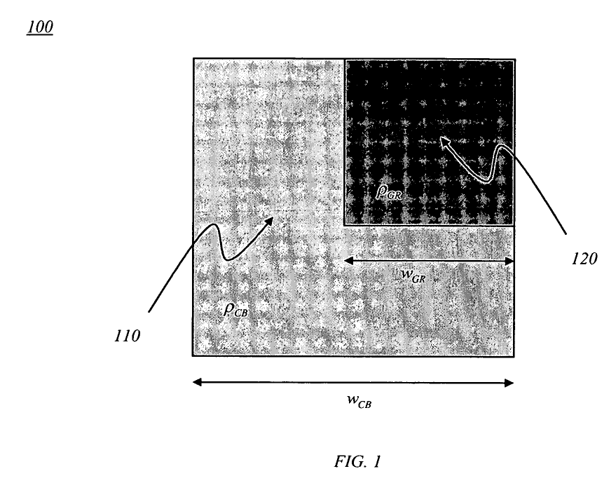

Referring to FIG. 1, there is shown a checking box 110 having a width (w_{CB}) which is larger than the checking box width specified by the groundrule (w_{GR}). Box 110 requires a smaller density, ρ_{CB}, in order to guarantee compliance with the groundrule density (ρ_{GR}) using the groundrule checking box 120. The pattern density is defined as

$$ρ = \frac{A}{{w}^{2}} \qquad ( 1 )$$

where A is the area of the design shapes under consideration within the area being checked. If design shapes of lesser area than A_{GR} do not exist within the checking box with edges of width w_{CB}, then it is not possible for shapes greater than or equal to area A_{GR} to exist within a smaller box fully enclosed within the first box. In the worst case, all of the area within the larger box is fully enclosed within a smaller box with dimensions w_{GR}. By applying equation (1) to ρ₁₂₀ and ρ₁₁₀ and then setting the area in each to be the same, it is found that

$$\frac{{w}_{GR}^{2}}{{w}_{CB}^{2}} = \frac{{ρ}_{CB , 110}}{{ρ}_{GR , 120}} \qquad ( 2 )$$

If w_{CB} is made to be an integer multiple n of w_{GR} or
w_{CB}=n·w_{GR} (3)
it then follows that

$${ρ}_{CB , 110} = \frac{{ρ}_{GR , 120}}{{n}^{2}} \qquad ( 4 )$$

Thus, any box that passes (i.e., the pattern is below the more stringent value of ρ₁₁₀) is also guaranteed to pass all the boxes with dimensions w_{GR} falling therein. As a result, it is not necessary to continue checking the box any further. In order to be able to quickly discard large areas, checking should begin by first performing a coarse scan of the entire layout with large checking boxes and correspondingly smaller density thresholds.

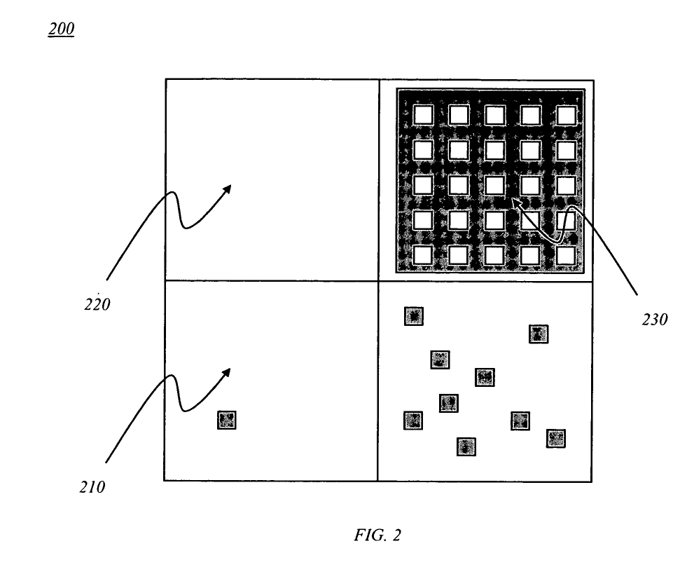

FIG. 2 illustrates possible subdivisions of a layout with large checking boxes. Numerals 210 and 220 illustrate large areas of the chip that pass the smaller ρ_{CB}. These are discarded without further checking because they are guaranteed to pass the local density rule based on equation (4). In contrast, numerals 230 and 240 are examples of boxes that do not pass a more stringent ρ_{CB}. These must be further subdivided into smaller checking boxes and checked to a ρ_{CB} specific to w_{CB}. The factor by which the area is subdivided is k. An area subdivided with a factor of k=2 will, in the two dimensional case, result in four subdivisions. This is the result of dividing both the width and the length by 2. The subdivision is subsequently analyzed in the same manner as the original area. The subdivision itself may also be subdivided using a variable factor so that in an iterative fashion, the checking box is reduced by the factor k. Areas that are guaranteed to pass are discarded. Areas that are guaranteed to fail are marked as failing, and the remaining questionable areas are subdivided into smaller checking boxes. Accordingly,

$${n}_{new} = \frac{n}{k} \qquad ( 5 )$$

The present invention further provides a method in which the factor k rather than being set is adaptively determined by the detected area in the larger checking box. There may be instances where the pattern is sufficiently dense but homogeneous throughout the design such that no areas are discarded at all. Numeral 230 represents an example of such a case, where a fracture with a fixed value of k becomes inefficient as many more pattern density checks are run than necessary. In the case given, k² should increase linearly with the measured area A_{CB}, but it must not be an integer smaller than 2.

$$k = max ( 2 , fix ( \sqrt{\frac{{A}_{CB , 110} {ρ}_{CB , 110}}{{ρ}_{GR , 120}}} ) ) \qquad ( 6 )$$

Such an approach accelerates the likelihood of finding an area that fails the pattern density.

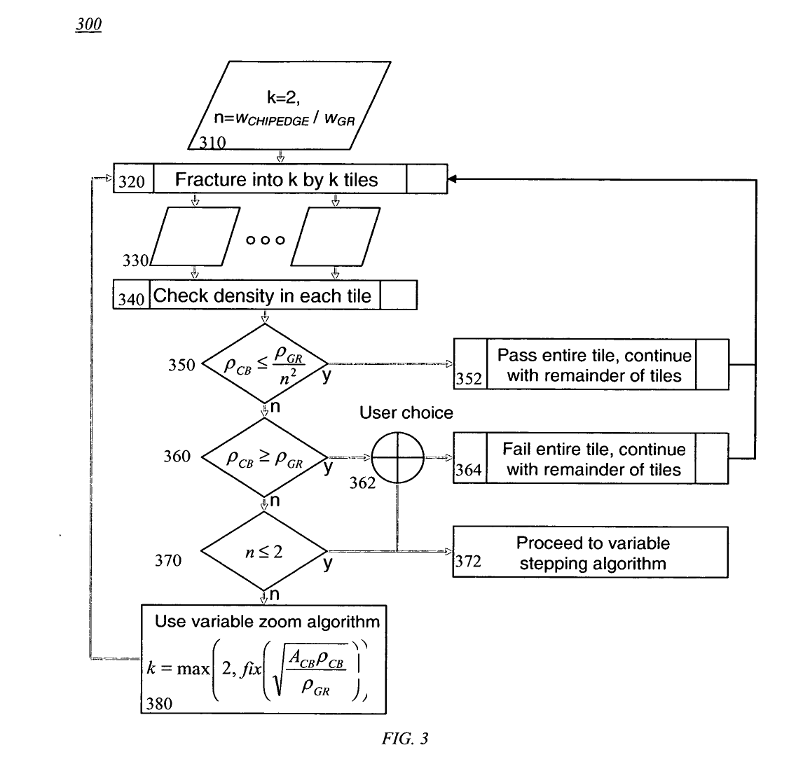

FIG. 3 is a flow chart describing the pattern density checking algorithm. For illustrative purposes, the algorithm assumes that the layout data is a square, i.e., the length and width of the chip are exactly the same. It is to be understood, though, that the algorithm works on any shapes. However, for simplicity, a square will be used hereinafter interchangeably.

Further referring to FIG. 3, in step 310, the checking routine begins with layout data consisting of shapes in two-dimensional space. Because no information regarding the pattern density is known, n is initialized to be the size of the chip edge, and k is initialized to 2. Step 320 breaks this data into k by k subdivisions 330. It follows that for the first time through the algorithm, the entire chip is broken into quarters.

In step 340, the density of each of the subdivisions 330 is calculated. Step 350 is a decision box. If the density of the subdivision (ρ_{CB}) is less than the density required by equation (1) above, then step 352 passes the entire subdivision and returns to 320 to work on the remaining subdivisions.

If the decision in 350 fails, then step 360 decides if ρ_{CB} is higher than ρ_{GR}. If the density is higher than ρ_{GR}, then by way of equation (4) it is guaranteed that a failing tile is present somewhere in the subdivision. Thus, step 362 gives the user the option of failing the entire tile, searching for the exact location of the density failure (364), or proceeding directly to the variable stepping algorithm (372). If the whole tile is failed, then the algorithm returns to step 320 to work on the remaining tiles.

If step 360 determines that ρ_{CB} is still less than ρ_{GR}, then step 370 checks how small the checking box is. If the checking box size is less than or equal to twice w_{GR}, then step 372 proceeds with the variable stepping algorithm.

If step 370 fails, then a new value for k is calculated using equation (6). The algorithm returns to step 320 until n is small (in this implementation, n is selected to be equal to 2), at which point an algorithm optimized to local checking of small areas is invoked (372).

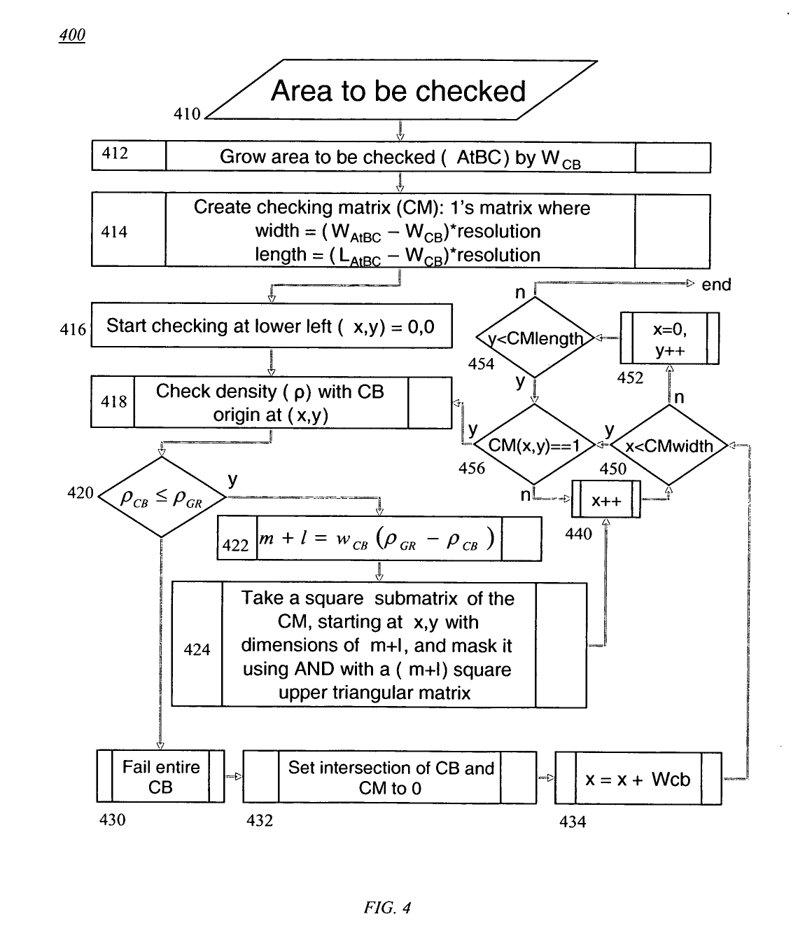

Referring now to FIG. 4, a flow chart of the variable stepping algorithm (372, FIG. 3) is shown. In step 410, each remaining area is checked by way of a box of n=1. To avoid splitting a failing pattern across the edge of the new checking area, it must be grown by a predetermined factor on each edge.

In step 412, the remaining area is selected to grow by w_{GR} per edge. However, it may also be grown adaptively based on the area of patterns detected therein.

In step 414, the remaining area is broken up as a “checking matrix”. Each element of the checking matrix represents possible n=1 checking box origins. The matrix is initialized with 1s. These elements will change from 1 (“fail”) to 0 (“pass”) when the densities are calculated and found to pass while the checking box scans the checking matrix. The stepping dimension must be on the order of the minimum feature size to ensure that failing patterns are not split between checking boxes. However, checking the entire remaining area with this step size is highly inefficient. Instead, a multiple of the step size may be calculated based on the measured density within the current checking box. Qualitatively, if the detected density inside the checking box is zero, the small stepping is unnecessary and a full step of w_{CB} is taken. However, if the density approaches that of the groundrule, then a smaller step is required.

In step 416, the algorithm is initialized by setting the checking box origin to (x,y)=(0,0), that is, the lower left of the area to be checked.

Step 418 represents the loop head, wherein the density of the checking box at (x,y) is calculated. At this point the algorithm proceeds to step 420 where the density of the checking box is compared to the groundrule density. If the checking box density is greater than the groundrule density, it then proceeds to step 430, where the entire checking box is marked as a fail. Alternatively, in step 420, if the checking box density is less than or equal to the groundrule density, it then branches to step 422 wherein the length of the adaptive next step is calculated.

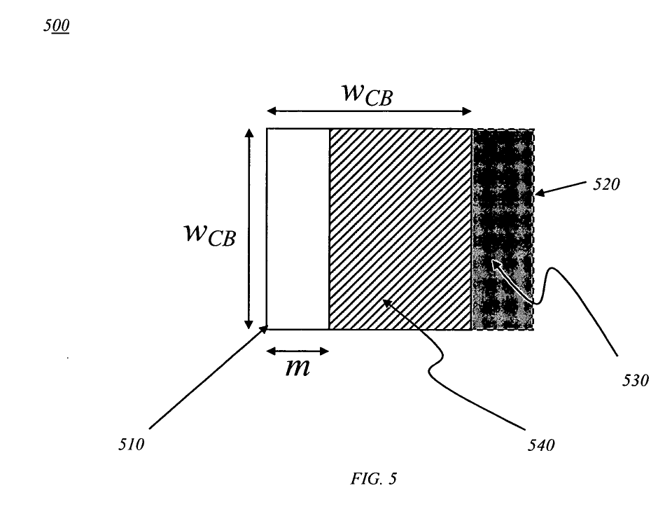

For the purposes of derivation of the adaptive step, assume one dimensional stepping across the remaining area as shown in FIG. 5. First, the pattern density within the checking box 510 is determined. The size of the step m must guarantee that the area moved outside of the checking box passes the groundrule density in the worst case. The worst case occurs when the entire area detected in checking box 510 remains within the next checking box 520, i.e., the hashed area 540. Furthermore, the area 530 in the new checking box 520 that was not in the previous checking box 510 contains solid pattern. This worst case relationship is shown in equation (7).
ρ_{wc,520}·w_{CB}²=ρ₅₁₀·w_{CB}²+m·w_{GR} (7)
where ρ₅₁₀ is the measured density from the checking box 510 and ρ_{wc,520}, the worst case density of the checking box 520. Assuming that the worst case density meets the groundrule density, i.e. ρ_{wc,520}=ρ_{GR}, the maximum step m is obtained using equation (8)
m=w_{GR}·(ρ_{GR}−ρ₅₁₀) (8)

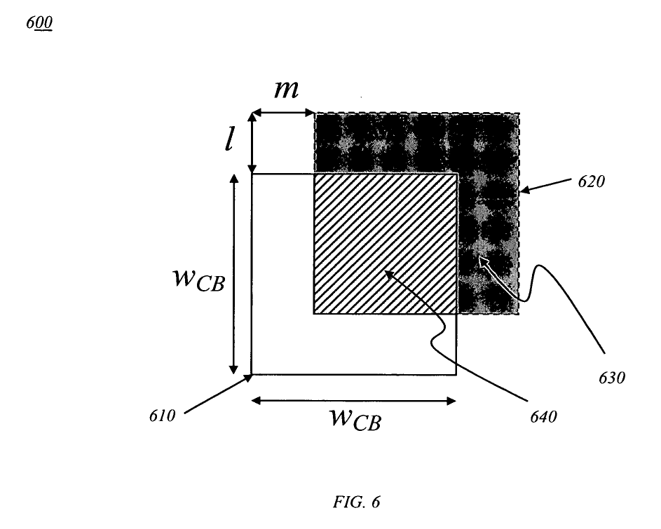

The problem is similar for stepping in two dimensions as illustrated in FIG. 6, i.e., in the x direction by stepping m, and in the y direction by stepping l. First, the pattern density within the checking box 610 is determined. The worst case density of the checking box 620 is calculated in the same manner as in the one-dimensional stepping case. Assuming that the area 630 within checking box 620 and outside checking box 610, are solid filled with the pattern of interest, and further, assuming that the entire area detected in checking box 610 is contained in 620, the worst case density of this two dimensional step is given in equation (9)
ρ_{wc,620}·w_{CB}²=ρ₆₁₀·w_{CB}²+m·w_{GR}+l·w_{GR}−ml (9)
where ρ₆₁₀ is the measured density of checking box 610 and ρ_{wc,620} is the worst case density of checking box 620. It is assumed that the worst case density meets the groundrule density, i.e., ρ_{wc,620}=ρ_{GR}. Moreover, to simplify this expression, the ml term that is due to subtracting the same area twice is ignored, and it is solved for the maximum two-dimensional step l+m in equation (10)
l+m=w_{GR}(ρ_{GR}−ρⁱ) (10)

Simplifying the expression by ignoring the double counted ml area makes the step more conservative than it needs to be. However, the simplification greatly reduces the computation involved to determine the maximum next step in two dimensions. Equation (10) shows that one may use a variable step in two dimensions by summing the stepping distance in both dimensions. By way of example, when checking an area much larger than the checking box, a simple approach is to raster scan the box across the area, by first variably stepping across the area in the x-dimension. What areas can be skipped is determined by evaluating the sum of the x and y step of the area in question and comparing it to the resultant pattern density of an earlier check.

Still referring to FIG. 4, the two dimensional step is implemented in step 424 by creating a square triangular matrix with dimensions l+m by applying equation (10). A square triangular matrix is filled with 1s in all the elements from the top left to the lower right and above. The elements below this diagonal are all 0s. This l+m matrix is ANDed with the sub-matrix of the checking matrix within the current checking box at (x, y). This step sets all the possible checking box origins within a distance of l+m from (x,y) to 0 or “pass.”

In step 440, x is incremented. Step 450 checks whether x has stepped beyond the end of the checking matrix width. If the value of x is greater than the width of the checking matrix, then step 452 increments the value of y and resets x to 0, such that we start the next row. If the algorithm has run through all the rows in the checking matrix, then step 454 exits the algorithm.

Otherwise, step 456 takes the new origin from either x being less than the checking matrix width in 450 or from the start of a new row in 454 and checks if the element is 1 or 0. If the element is 0, then step 424 has already determined that this origin will pass the groundrule density under consideration. The algorithm returns to step 440 to increment to the next element of the checking matrix. If, in step 456 the element is 1, then the algorithm returns to 418 and continues with the variable stepping density check.

Step 418, which was previously described, checks the density. It then proceeds with step 420 where a comparison is executed. The path taken in the case where the checking box density is less than or equal to the groundrule density has previously been described.

In another possibility, at step 420 in the case where the checking box density is greater than the groundrule density, a branch to step 430 may take place where one recognizes that the entire tile has failed.

Proceeding to step 432, all the elements in the current checking box are set to 0, corresponding to a fail. In step 434, x is incremented by the entire checking box width. The new value of x is then passed on to step 450 that was previously described. Incrementing x or y represents a variable step.

As mentioned previously, the algorithm stops once checking box has stepped across the entire design, which is the case when y exceeds the length of the checking matrix (step 454).

While the present invention has been particularly described in conjunction with specific embodiments, it is evident that other alternatives, modifications and variations will be apparent to those skilled in the art in light of the present description. It is therefore contemplated that the appended claims will embrace any such alternatives, modifications and variations as falling within the true scope and spirit of the present invention.

What is claimed is:

1. A method for checking the density of a chip layout comprising the steps of:
a) setting dimensions of an area to be checked, determining the area of the pattern contained therein, and determining its associated pattern density;
b) determining whether the associated pattern density guarantees a pass or fail when compared to a groundrule checking box size and its corresponding pattern density;
c) subdividing the checked area based on: 1) the associated pattern density; 2) the size of the area to be checked; and 3) the groundrule checking box size and pattern density thereof; and
d) iteratively repeating steps a) through c) for each subdivided area.

2. The method of claim 1 wherein the iteration step d) ends when the size of the subdivided area reaches a threshold that is greater than the groundrule checking box.

3. The method of claim 1 further comprising the step of expanding the subdivided area by a predetermined factor prior to further checking.

4. The method of claim 1 further comprising the step of expanding the subdivided area by a predetermined constant prior to further checking.

5. The method of claim 1 wherein in step b) the area of the fixed pattern and the pattern area required to fail the pattern density groundrule are compared to each other.

6. The method of claim 5, further comprising the steps of:
i. determining successive checking box sizes based on the area of the pattern contained within the checked area; and
ii. prioritizing the checked areas starting with the one having the highest density; and
iii. subdividing and further checking in order of priority.

7. The method of claim 1 wherein steps c) and d) are replaced by the step of eliminating the checked areas that are guaranteed to pass from further checking.

8. The method of claim 1 wherein steps c) and d) are replaced by the step of eliminating the checked areas that are guaranteed to fail from further checking.

9. The method of claim 8 wherein the checked areas that are guaranteed to fail are tagged for future reference.

10. The method of claim 1 wherein step c) further comprises the step of tagging for future reference the checked areas that are guaranteed to fail.

11. The method of claim 1, wherein in step a) the area checked is an entire chip.

12. The method of claim 1, wherein in step a) the area checked is a portion of the chip.

13. A method for checking the density of a chip layout comprising the steps of:
a) superimposing a fixed size checking box over an area to be checked;
b) determining the area of the pattern contained within the checking box, and its associated pattern density;
c) determining whether the associated pattern density constitutes a pass or fail when compared to a groundrule pattern density;
d) moving the fixed size checking box a distance based on 1) the associated pattern density; 2) the area of the fixed size checking box; and 3) the groundrule pattern density; and
e) iteratively repeating steps a) through d).

14. The method of claim 13, wherein the movement in step d) is in one dimension.

15. The method of claim 13, wherein the movement in step d) is in two dimensions.

16. The method of claim 13, wherein step c) further comprises the step of tagging an area that is guaranteed to fail.

17. The method of claim 13, wherein step d) is replaced by the step of moving the checking box a distance equal to a dimension of the checking box when the associated pattern density constitutes a fail.

18. The method of claim 13, wherein in step c) is replaced by the step of determining whether the associated area constitutes a pass or fail when compared to the area required to achieve the groundrule pattern density

19. The method of claim 13, wherein the area checked in step a) is an area that requires further checking determined by the following steps:
a) setting dimensions of an area to be checked, determining the area of the pattern contained therein, and determining its associated pattern density;
b) determining whether the associated pattern density guarantees a pass or fail when compared to a groundrule checking box size and its corresponding pattern density;
c) subdividing the checked area based on: 1) the associated pattern density; 2) the size of the area to be checked; and 3) the groundrule checking box size and pattern density thereof, if the checked area is larger than a threshold area;
d) iteratively repeating steps a) through c) for each subdivided area; and
e) a checked area smaller than the threshold area is the area that requires further checking

20. The method of claim 19, wherein in step e) the area that requires further checking is comprised of multiple checked areas smaller than the threshold area.

21. A program storage device readable by a machine, tangibly embodying a program of instructions executable by the machine to perform method steps for checking the density of a chip layout, said method steps comprising:
a) setting dimensions of an area to be checked, determining the area of the pattern contained therein, and determining its associated pattern density;
b) determining whether the associated pattern density guarantees a pass or fail when compared to a groundrule checking box size and its corresponding pattern density;
c) subdividing the checked area based on: 1) the associated pattern density; 2) the size of the area to be checked; and 3) the groundrule checking box size and pattern density thereof; and
d) iteratively repeating steps a) through c) for each subdivided area.
